(19) United States
(12) Patent Application Publication
(10) Pub. No.: US 2020/0348081 A1
(43) Pub. Date: Nov. 5, 2020

(54) Device for supporting and guiding a flow for metallic workpieces, and method for thermochemical treatment

(71) Applicant: ALD VACUUM TECHNOLOGIES GMBH, Hanau (DE)

(72) Inventor: Volker HEUER, Frankfurt a.M. (DE)

(73) Assignee: ALD VACUUM TECHNOLOGIES GMBH, Hanau (DE)

(21) Appl. No.: 16/961,010

(22) PCT Filed: Jan. 29, 2019
(86) PCT No.: PCT/EP2019/052059

§ 371 Date: Jul. 9, 2020

(30) Foreign Application Priority Data
Jan. 30, 2018 (DE) 10 2018 101 994.7

(51) Int. Cl. F27D 5/00; C23C 8/22; C23C 8/32; C21D 1/18; C21D 1/62; C04B 35/83

(52) U.S. Cl. CPC F27D 5/0006; C23C 8/22; C23C 8/32; C04B 2235/422; C21D 1/62; C04B 35/83; C04B 2235/5248; C21D 1/18

(57) ABSTRACT

The present invention relates to devices used during the thermomechanical treatment of workpieces. During thermochemical treatment, metallic workpieces are mounted on and/or shielded by a high-temperature-resistant device configured specifically for this purpose in order to reduce dimensional and shape changes or warping. The inventive devices provide support and flow guiding for metallic workpieces during thermochemical treatment, and include a plate or a ring having a first and a second face, in which the second face is equipped with three or more support elements and the support elements are bound to a support plane.

The present invention relates to a device for support and flow guiding for metallic workpieces in thermochemical treatment, and to a method of thermochemical treatment of one, two or more metallic workpieces.

It is customary in the art to subject metallic workpieces to thermochemical treatment, for example gearwheels. One of the most commonly used methods is case hardening (https://de.wikipedia.org/wiki/Einsatzharten), in which workpieces made of steel or other alloys are carburized, diffused and quenched in order to produce a layer having a particular, preferably martensitic, microstructure at the surface of the workpieces. Further thermochemical methods are carbonitriding, in which carbon and nitrogen are introduced into the workpieces, and nitriding, in which solely nitrogen is introduced.

In thermochemical treatment by means of carburizing and carbonitriding, the workpieces are kept at temperatures in the range from 800 to 1100° C. over a period of time of 30 min up to a few hours.

In thermochemical treatment, predominantly batches having a piece count or batch size of a few tens to a few hundred workpieces are treated in specially designed systems having one or more lock chambers, furnace chambers and quench chambers. In exceptional cases, for example transmission gears having a diameter of more than 600 mm or machine parts having high precision demands, the workpieces are treated sequentially (one-piece flow), with each individual workpiece subjected to one of the thermochemical method steps in a treatment chamber.

Small components having an uncritical manufacturing tolerance are frequently treated in the form of bulk material-like batches having a piece count of a few hundred to a few thousand workpieces. By contrast, larger and higher-quality components are arranged in an ordered manner on batch carriers in order to assure controlled process conditions of maximum uniformity. Particular aims are uniform temperature distribution and contacting of the workpieces with carbon- and nitrogen-containing process gases, and uniform flow of quench fluid around the workpiece surface.

The batch carriers are generally in the form of lattice-like grids and consist of a material of high thermal stability, such as graphite, carbon fiber-reinforced carbon (CFRC) or high-nickel steel. The production of the batch carriers is complex and costly. In order to perform the thermochemical treatment economically, the batch carriers are used for as long as possible, i.e. for the treatment of numerous workpiece batches, and are subjected to high mechanical and thermal stress. In the loading and unloading of the batch carriers with workpieces, there is mechanical abrasion. Moreover, in the case of high-nickel steels, the numerous heating and quenching operations result in cumulative thermal warpage. The result of the progressive mechanical and thermal stress is that the surface of the batch carriers has slight unevenness and warpage even after a few production runs.

Workpieces made of steel—according to the steel type—can be forged, i.e. are plastically deformable under application of force, over and above a temperature in the range from 500 to 800° C. In the context of the present invention, this temperature, in line with plastics, is referred to as “softening temperature” or “softening point”.

In carburizing and carbonitriding, the workpieces are regularly kept at a temperature above their “softening point” over a considerable period of time.

A workpiece that is being borne on a batch carrier and has been heated above its “softening point” huddles against the surface of the batch carrier under its own weight. If the surface of the batch carrier is sufficiently flat, such that the local curvature is very small or the local radius of curvature is very large compared to the dimensions of the workpieces, the warpage of the workpieces through heat treatment is minor and is within defined tolerances. However, if the surface of the batch carrier has one or more points of unevenness with considerable curvature or a radius of curvature below a critical limit, the warpage of the workpieces through heat treatment can exceed the tolerances and cause a considerable increase in reject rate.

Furthermore, nonuniform flow of cooling fluid over the workpieces in the course of quenching can likewise cause warpage of the workpieces.

It is an object of the present invention to provide a device for the reduction of the changes in dimensions and shape or warpage of metallic workpieces in thermochemical treatment.

This object is achieved by a device for support and flow guiding for metallic workpieces in thermochemical treatment, comprising a plate or a ring having a first and second face, wherein the second face is equipped with three or more support elements and the support elements bound a support plane.

Advantageous embodiments of the device of the invention are detailed hereinafter.

Device, as described above, wherein the first face has a planar outer surface.

Device, as described above, wherein the support plane bounded by the support elements is plane-parallel to the outer surface of the first face.

Device, as described above, wherein the plate or the ring and the support elements are in one-piece form.

Device, as described above, wherein the support elements are in the form of lands.

Device, as described above, wherein the support elements are in the form of circular lands.

Device, as described above, wherein the support elements are in the form of radial lands.

Device, as described above, wherein recesses are disposed between adjacent support elements.

Device, as described above, wherein grooves are disposed between adjacent support elements.

Device, as described above, wherein the second face has circular recesses.

Device, as described above, wherein the second face has circular grooves.

Device, as described above, wherein the second face has radial recesses.

Device, as described above, wherein the second face has radial grooves.

Device, as described above, wherein the second face has circular and radial recesses.

Device, as described above, wherein the second face has circular and radial grooves.

Device, as described above, wherein the second face is equipped with receptacles for support elements.

Device, as described above, wherein the receptacles are in the form of grooves.

Device, as described above, wherein the support elements are in the form of round bars.

Device, as described above, wherein the plate or the ring is made from graphite or carbon fiber-reinforced carbon (CFRC).

Device, as described above, wherein the support elements are made from graphite, carbon fiber-reinforced carbon (CFRC), oxide-ceramic fiber matrix composite (OCMC) or another ceramic material.

Device, as described above, wherein a surface of the support elements has been equipped with particles of a ceramic material and the particles have an equivalent diameter in the range from 5 to 1000 nm.

Device, as described above, having channels for passage of fluids that connect the first and second face.

Device, as described above, wherein the channels are in the form of holes.

Device, as described above, wherein the receptacles are in the form of radial grooves.

Device, as described above, wherein the receptacles are in the form of grooves having rectangular cross section.

Device, as described above, wherein the receptacles are in the form of grooves having triangular cross section.

Device, as described above, wherein the support elements take the form of round bars with circular cross section with diameter Dₛ, the receptacles take the form of grooves and have a cross section in the form of an equilateral triangle having a base side of length c and a vertex angle γ, the vertex angle γ is in the range from 60° to 120° (60°≤γ120°)and the length c satisfies the relation Dₛ·cos(γ/2)<c<Dₛ·cot(45°−γ/4).

Device, as described above, wherein the receptacles take the form of grooves having trapezoidal cross section.

Device, as described above, wherein the support elements take the form of round bars with circular cross section with diameter Dₛ, the receptacles take the form of grooves and have a cross section in the form of a symmetric trapezium having a long base side of length a and a short base side of length b, an angle ε enclosed by the limbs of the trapezium is in the range from 60° to 120° (60°≤ε120°), the length a satisfies the relation Dₛ·cos(ε/2)<a<Dₛ·cot(45°−ε/4) and the length b satisfies the relation 0<b<Dₛ·cot(45°+ε/4).

Device, as described above, wherein each support element has a planar support surface.

Device, as described above, wherein each support element has a planar support surface and the support surfaces lie in the support plane.

Device, as described above, wherein each support element has a planar support surface and the support surfaces of the support elements are of equal size.

Device, as described above, wherein the outer surface of the first face has a flatness (axial runout) of ≤10 μm.

Device, as described above, wherein the second face has a flatness (axial runout) of ≤10 μm.

Device, as described above, wherein the support faces of the support elements have a flatness (axial runout) of ≤10 μm.

Device, as described above, comprising N support elements with 4≤N≤12, 8≤N≤16, 12≤N≤20, 16≤N≤24, 20≤N≤28, 24≤N≤32, 28≤N≤36 or 42≤N≤50.

Device, as described above, comprising N support elements with 10≤N≤30, 20≤N≤40, 30≤N≤50, 40≤N≤60, 50≤N≤70, 60≤N≤80, 70≤N≤90 or 80≤N≤100.

Device, as described above, comprising N support elements with 10≤N≤100, 20≤N≤100, 30≤N≤100, 40≤N≤100, 50≤N≤100, 60≤N≤100, 70≤N≤100, 80≤N≤100 or 90≤N≤100.

Device, as described above, comprising N support elements with 10≤N≤200, 20≤N≤200, 30≤N≤200, 40≤N≤200, 50≤N≤200, 60≤N≤200, 70≤N≤200, 80≤N≤200, 90≤N≤200, 100≤N≤200, 110≤N≤200, 120≤N≤200, 130≤N≤200, 140≤N≤200, 150≤N≤200, 160≤N≤200, 170≤N≤200, 180≤N≤200 or 190≤N≤200.

Device, as described above, wherein a perpendicular distance between the outer surface of the first face and a support plane bounded by the support elements is 10 to 200 mm.

Device, as described above, wherein the plate or the ring has a cross section having cross-sectional area Q.

Device, as described above, wherein the plate or the ring has a cross section having a polygonal or circular outer contour.

Device, as described above, wherein the plate has a cross section in the form of an equilateral polygon having 4 to 12 vertices.

Device, as described above, wherein the plate has a cross section in the form of an equilateral hexagon.

Device, as described above, wherein the ring has a cross section having a circular inner contour and an equilateral polygonal outer contour having 4 to 12 vertices.

Device, as described above, wherein the ring has a cross section having a circular inner contour and an equilateral polygonal outer contour having 4 to 12 vertices, and the circular inner contour and polygonal outer contour are concentric.

Device, as described above, wherein the ring has a cross section having a circular inner contour and equilateral hexagonal outer contour.

Device, as described above, wherein the ring has a cross section having a circular inner contour and equilateral hexagonal outer contour, and the circular inner contour and polygonal outer contour are concentric.

Device, as described above, comprising a plate or a ring having a cross section having an envelope circle having diameter Dₐ.

Device, as described above, comprising a plate having a circular cross section having diameter Dₐ and cross-sectional area

$$Q = \frac{π}{4} {D}_{a}^{2} .$$

Device, as described above, comprising a ring having a cross section having a circular inner contour with diameter Dᵢ and an outer contour having an envelope circle having diameter Dₐ.

Device, as described above, comprising a ring having a circular inner contour with diameter Dᵢ, circular outer contour with diameter Dₐ and a cross-sectional area Q with

$$Q = \frac{π}{4} ( {D}_{a}^{2} - {D}_{i}^{2} ) .$$

Device, as described above, comprising a ring, where 0.1·ₐ≤Dᵢ≤0.9·Dₐ.

Device, as described above, comprising a ring, where 0.1·Dₐ≤Dᵢ≤0.3·Dₐ, 0.2·Dₐ≤Dᵢ≤0.4·Dₐ, 0.3·Dₐ≤Dᵢ≤0.5·Dₐ, 0.4·Dₐ≤Dᵢ≤0.6·Dₐ, 0.5·Dₐ≤Dᵢ≤0.7·Dₐ, 0.6·Dₐ≤Dᵢ≤0.8·Dₐ or 0.7·Dₐ≤Dᵢ≤0.9·Dₐ.

Device, as described above, comprising a ring with 20 mm D≤Dᵢ≤1980 mm.

Device, as described above, comprising a ring with 20 mm≤Dᵢ≤200 mm, 100 mm≤Dᵢ≤300 mm, 200 mm≤Dᵢ≤400 mm, 300 mm≤Dᵢ≤500 mm or 400 mm≤Dᵢ≤600 mm.

Device, as described above, comprising a ring with 20 mm≤Dᵢ≤400 mm, 200 mm≤Dᵢ≤600 mm, 400 mm≤Dᵢ≤800 mm, 600 mm≤Dᵢ≤1000 mm, 800 mm≤Dᵢ≤1200 mm, 1000 mm≤Dᵢ≤1400 mm 1200 mm≤Dᵢ≤1600 mm, 1400 mm≤Dᵢ≤1800 mm or 1600 mm≤Dᵢ≤1980 mm.

Device, as described above, comprising a plate or a ring, wherein 40 mm≤Dₐ≤2000 mm.

Device, as described above, comprising a plate or a ring, wherein 40 mm≤Dₐ≤200 mm, 100 mm≤Dₐ≤300 mm, 200 mm≤Dₐ≤400 mm, 300 mm≤Dₐ≤500 mm or 400 mm≤Dₐ≤600 mm.

Device, as described above, comprising a plate or a ring, wherein 40 mm≤Dₐ≤400 mm, 200 mm≤Dₐ≤600 mm, 400 mm≤Dₐ≤800 mm, 600 mm≤Dₐ≤1000 mm, 800 mm≤Dₐ≤1200 mm, 1000 mm≤Dₐ≤1400 mm, 1200 mm≤Dₐ≤1600 mm, 1400 mm≤Dₐ≤1800 mm or 1600 mm≤Dₐ≤2000 mm.

Device, as described above, comprising a ring, wherein 4 mm≤Dₐ−Dᵢ≤400 mm.

Device, as described above, comprising a ring, wherein 30 mm≤(Dₐ+Dᵢ)/2≤1800 mm.

Device, as described above, wherein a distance perpendicular to the support plane between the first face and the support plane is 10 to 200 mm.

Device, as described above, wherein a distance perpendicular to the support plane between the first face and the support plane is 10 to 30 mm, 20 to 40 mm, 30 to 50 mm, 40 to 60 mm, 50 to 70 mm, 60 to 80 mm, 70 to 90 mm, 80 to 100 mm, 90 to 110 mm, 100 to 120 mm, 110 to 130 mm, 120 to 140 mm, 130 to 150 mm, 140 to 160 mm, 150 to 170 mm, 160 to 180 mm, 170 to 190 mm or 180 to 200 mm.

Device, as described above, wherein each support element has a planar support surface and the sum total of the support surfaces of all support elements is 1% to 80% of the cross-sectional area Q.

Device, as described above, wherein each support element has a planar support surface and the sum total of the support surfaces of all support elements is 10% to 80% of the cross-sectional area Q.

Device, as described above, wherein each support element has a planar support surface and the sum total of the support surfaces of all support elements is 10% to 70% of the cross-sectional area Q.

Device, as described above, wherein each support element has a planar support surface and the sum total of the support surfaces of all support elements is 10% to 60% of the cross-sectional area Q.

Device, as described above, wherein each support element has a planar support surface and the sum total of the support surfaces of all support elements is 10% to 50% of the cross-sectional area Q.

Device, as described above, wherein each support element has a planar support surface and the sum total of the support surfaces of all support elements is 10% to 40% of the cross-sectional area Q.

Device, as described above, wherein each support element has a planar support surface and the sum total of the support surfaces of all support elements is 10% to 30% of the cross-sectional area Q.

Device, as described above, wherein each support element has a planar support surface and the sum total of the support surfaces of all support elements is 10% to 20% of the cross-sectional area Q.

Device, as described above, wherein each support element has a planar support surface and the sum total of the support surfaces of all support elements is 25% to 40% of the cross-sectional area Q.

Device, as described above, wherein each support element has a planar support surface and the sum total of the support surfaces of all support elements is 30% to 36% of the cross-sectional area Q.

Device, as described above, comprising a plate or a ring having cross-sectional area Q and N support elements, wherein each support element has a planar support surface and a clear distance w between the support surfaces of adjacent support elements satisfies the condition

$$0.8 \; 75 \sqrt{\frac{Q}{N}} ( 1 - \sqrt{x} ) \leq w \leq 1.2 \; 75 \sqrt{\frac{Q}{N}} ( 1 - \sqrt{x} )$$

where x is the quotient of the sum total of the support surfaces of all support elements divided by Q.

Device, as described above, comprising a plate or a ring having cross-sectional area Q and N support elements, wherein each support element has a planar support surface and a clear distance w between the support surfaces of adjacent support elements satisfies the condition

$$0.9 \; 75 \sqrt{\frac{Q}{N}} ( 1 - \sqrt{x} ) \leq w \leq 1.1 \; 75 \sqrt{\frac{Q}{N}} ( 1 - \sqrt{x} )$$

where x is the quotient of the sum total of the support surfaces of all support elements divided by Q.

Device, as described above, comprising a plate or a ring having cross-sectional area Q and N support elements, wherein each support element has a planar support surface and a clear distance w between the support surfaces of adjacent support elements satisfies the condition

$$1.0 \; 25 \sqrt{\frac{Q}{N}} ( 1 - \sqrt{x} ) \leq w \leq 1.1 \; 25 \sqrt{\frac{Q}{N}} ( 1 - \sqrt{x} )$$

where x is the quotient of the sum total of the support surfaces of all support elements divided by Q.

Device, as described above, wherein the support elements each have an equilateral hexagonal cross section and are arranged in a two-dimensionally periodic pattern having hexagonal symmetry, wherein an axis running through two opposite vertices of hexagonal cross section of a support element, relative to an axis that runs through two vertices of the periodic hexagonal pattern, has an angle of inclination of 30, 90, 150, 210, 270 or 330 degrees.

It is a further object of the invention to provide a method for the thermochemical treatment of metallic workpieces having a reduction in the change in dimensions and shape or reduced warpage compared to known methods.

This object is achieved by a method of thermochemical treatment of one, two or more metallic workpieces, wherein a device, as described above, is disposed on the first and/or second side of each workpiece.

Advantageous embodiments of the method of the invention are set out hereinafter.

Method, as described above, wherein each workpiece is borne on a device.

Method, as described above, wherein each workpiece is borne on a device disposed beneath the workpiece.

Method, as described above, wherein a device rests on each workpiece.

Method, as described above, wherein a device disposed above the workpiece rests on each workpiece.

Method, as described above, wherein a side of the device equipped with support elements faces the workpiece.

Method, as described above, wherein a first side of each workpiece is borne on a first device and a second device rests on a second side of the workpiece opposite the first side.

Method, as described above, wherein a side of the first device equipped with support elements and a side of the second device equipped with support elements faces the workpiece.

Method, as described above, wherein the device comprises three or more support elements that are in mechanical contact with the workpiece.

Method, as described above, wherein one, two or more workpieces are carburized together.

Method, as described above, wherein one, two or more workpieces are carburized together at temperatures of 900 to 1050° C.

Method, as described above, wherein one, two or more workpieces are carburized together in a carbonaceous gas atmosphere at a pressure of less than 200 mbar.

Method, as described above, wherein one, two or more workpieces are carburized together in a carbonaceous gas atmosphere at a pressure of less than 50 mbar.

Method, as described above, wherein one, two or more workpieces are carburized together in a furnace chamber and one workpiece in each case is disposed in a vertical direction between an upper and lower wall of the heating chamber.

Method, as described above, wherein one, two or more workpieces are carbonitrided together.

Method, as described above, wherein one, two or more workpieces are carbonitrided together at temperatures of 800 to 1050° C.

Method, as described above, wherein one, two or more workpieces are carbonitrided together in a nitrogenous gas atmosphere at a pressure of less than 200 mbar.

Method, as described above, wherein one, two or more workpieces are carbonitrided together in a furnace chamber and one workpiece in each case is disposed in a vertical direction between an upper and lower wall of the heating chamber.

Method, as described above, wherein one, two or more workpieces are carburized together and/or carbonitrided together and subsequently quenched together.

Method, as described above, wherein one, two or more workpieces are quenched together by means of a gas.

Method, as described above, wherein one, two or more workpieces are quenched together by means of nitrogen.

Method, as described above, wherein one, two or more workpieces are quenched together by means of helium.

Method, as described above, wherein one, two or more workpieces are quenched together by means of argon.

Method, as described above, wherein one, two or more workpieces are quenched together by means of a gas under a pressure of 1 to 40 bar.

Method, as described above, wherein one, two or more workpieces are quenched together by means of a gas under a pressure of 2 to 20 bar.

Method, as described above, wherein one, two or more workpieces are quenched together in a quench chamber and one workpiece in each case is arranged in a vertical direction between an upper and lower wall of the quench chamber.

Method, as described above, wherein one, two or more workpieces are quenched together by means of a liquid, for example an oil.

Method, as described above, wherein one, two or more devices each with a workpiece supported on the device are disposed together on a carrier.

Method, as described above, wherein the carrier is made from graphite, carbon fiber-reinforced carbon (CFRC) or high-nickel steel.

Method, as described above, wherein the carrier is in the form of a lattice.

Method, as described above, wherein the workpieces are in the form of gearwheels.

Method, as described above, wherein the workpieces have a cross section with an envelope circle having diameter D_{K}.

Method, as described above, wherein the workpieces take the form of gearwheels with tip circle diameter D_{K}.

Method, as described above, wherein the device comprises a plate or a ring having a cross section having an envelope circle with diameter Dₐ.

Method, as described above, wherein the device comprises a plate having a cross section with polygonal outer contour having an envelope circle with diameter Dₐ.

Method, as described above, wherein the device comprises a plate having a circular cross section with diameter Dₐ.

Method, as described above, wherein the device comprises a ring having a cross section with a polygonal outer contour having an envelope circle with diameter Dₐ.

Method, as described above, wherein the device comprises a ring having a cross section with a circular outer contour with diameter Dₐ.

Method, as described above, wherein 0.5·Dₐ≤1.2·Dₖ.

Method, as described above, wherein 0.5·Dₖ≤Dₐ≤1.2·Dₖ≤Dₐ≤0.65·Dₖ, 0.6·Dₖ≤Dₐ≤0.7·Dₖ, 0.65·Dₖ≤Dₐ≤0.75·Dₖ, 0.7·Dₖ≤Dₐ≤0.8·Dₖ, 0.75·Dₖ≤Dₐ≤0.85·Dₖ, 0.8·Dₖ≤Dₐ≤0.9·Dₖ, 0.85·Dₖ≤Dₐ≤0.95·Dₖ, 0.9·Dₖ≤Dₐ≤1.0·Dₖ, 0.95·Dₖ≤Dₐ≤1.05·Dₖ, 1.0·Dₖ≤Dₐ≤1.1·Dₖ, 10.5·Dₖ≤Dₐ≤1.15·Dₖ or 1.1·Dₖ≤Dₐ≤1.2·Dₖ.

Method, as described above, wherein each workpiece takes the form of a gearwheel having a gear ring and a flange, and the flange is borne on the device.

Method, as described above, wherein each workpiece takes the form of a gearwheel having a gear ring and a flange, and the device rests on the flange.

Method, as described above, wherein each workpiece takes the form of a gearwheel having a gear ring and a flange, and a face of the flange is supported by means of the device.

Method, as described above, wherein each workpiece takes the form of a gearwheel having a gear ring and a flange, and the device rests on a face of the flange.

Method, as described above, wherein each workpiece takes the form of a gearwheel having a gear ring and a flange, and a face of the flange is supported by means of the device, with 1% to 99% of the face of the flange in mechanical contact with the device.

Method, as described above, wherein each workpiece takes the form of a gearwheel having a gear ring and a flange, and the device rests on a face of the flange, with 1% to 99% of the face of the flange in mechanical contact with the device.

Method, as described above, wherein each workpiece takes the form of a gearwheel having a gear ring and a flange, and a face of the flange is supported by means of the device, with 1% to 20% of the face of the flange in mechanical contact with the device.

Method, as described above, wherein each workpiece takes the form of a gearwheel having a gear ring and a flange, and the device rests on a face of the flange, with 1% to 20% of the face of the flange in mechanical contact with the device.

Method, as described above, wherein each workpiece takes the form of a gearwheel having a gear ring and a flange, and a face of the flange is supported by means of the device, with 10% to 30% of the face of the flange in mechanical contact with the device.

Method, as described above, wherein each workpiece takes the form of a gearwheel having a gear ring and a flange, and the device rests on a face of the flange, with 10% to 30% of the face of the flange in mechanical contact with the device.

Method, as described above, wherein each workpiece takes the form of a gearwheel having a gear ring and a flange, and a face of the flange is supported by means of the device, with 20% to 40% of the face of the flange in mechanical contact with the device.

Method, as described above, wherein each workpiece takes the form of a gearwheel having a gear ring and a flange, and the device rests on a face of the flange, with 20% to 40% of the face of the flange in mechanical contact with the device.

Method, as described above, wherein each workpiece takes the form of a gearwheel having a gear ring and a flange, and a face of the flange is supported by means of the device, with 30% to 50% of the face of the flange in mechanical contact with the device.

Method, as described above, wherein each workpiece takes the form of a gearwheel having a gear ring and a flange, and the device rests on a face of the flange, with 30% to 50% of the face of the flange in mechanical contact with the device.

Method, as described above, wherein each workpiece takes the form of a gearwheel having a gear ring and a flange, and a face of the flange is supported by means of the device, with 40% to 60% of the face of the flange in mechanical contact with the device.

Method, as described above, wherein each workpiece takes the form of a gearwheel having a gear ring and a flange, and the device rests on a face of the flange, with 40% to 60% of the face of the flange in mechanical contact with the device.

Method, as described above, wherein each workpiece takes the form of a gearwheel having a gear ring and a flange, and a face of the flange is supported by means of the device, with 50% to 70% of the face of the flange in mechanical contact with the device.

Method, as described above, wherein each workpiece takes the form of a gearwheel having a gear ring and a flange, and the device rests on a face of the flange, with 50% to 70% of the face of the flange in mechanical contact with the device.

Method, as described above, wherein each workpiece takes the form of a gearwheel having a gear ring and a flange, and a face of the flange is supported by means of the device, with 60% to 80% of the face of the flange in mechanical contact with the device.

Method, as described above, wherein each workpiece takes the form of a gearwheel having a gear ring and a flange, and the device rests on a face of the flange, with 60% to 80% of the face of the flange in mechanical contact with the device.

Method, as described above, wherein each workpiece takes the form of a gearwheel having a gear ring and a flange, and a face of the flange is supported by means of the device, with 70% to 90% of the face of the flange in mechanical contact with the device.

Method, as described above, wherein each workpiece takes the form of a gearwheel having a gear ring and a flange, and the device rests on a face of the flange, with 70% to 90% of the face of the flange in mechanical contact with the device.

Method, as described above, wherein each workpiece takes the form of a gearwheel having a gear ring and a flange, and a face of the flange is supported by means of the device, with 80% to 99% of the face of the flange in mechanical contact with the device.

Method, as described above, wherein each workpiece takes the form of a gearwheel having a gear ring and a flange, and the device rests on a face of the flange, with 80% to 99% of the face of the flange in mechanical contact with the device.

Method, as described above, wherein the workpieces take the form of gearwheels and comprise a gear ring and a flange having external diameter D₂.

Method, as described above, wherein the device takes the form of a plate or ring and a diameter Dₐ of an envelope circle of a cross section of the plate or ring is less than the external diameter D₂ of the flange of the gearwheels.

Method, as described above, wherein the device takes the form of a plate or ring and a diameter Dₐ of an envelope circle of a cross section of the plate or ring is 50% to 99% of the external diameter D₂ of the flange of the gearwheels (0.5·D₂≤Dₐ≤0.99·D₂).

Method, as described above, wherein the device takes the form of a plate or ring and a diameter Dₐ of an envelope circle of a cross section of the plate or ring is 60% to 99% of the external diameter D₂ of the flange of the gearwheels (0.6·D₂≤Dₐ≤0.99·D₂).

Method, as described above, wherein the device takes the form of a plate or ring and a diameter Da of an envelope circle of a cross section of the plate or ring is 70% to 99% of the external diameter D₂ of the flange of the gearwheels (0.7·D₂≤Dₐ≤0.99·D₂).

Method, as described above, wherein the device takes the form of a plate or ring and a diameter Dₐ of an envelope circle of a cross section of the plate or ring is 80% to 99% of the external diameter D₂ of the flange of the gearwheels (0.8·D₂≤Dₐ≤0.99·D₂).

Method, as described above, wherein the device takes the form of a plate or ring and a diameter Dₐ of an envelope circle of a cross section of the plate or ring is 90% to 99% of the external diameter D₂ of the flange of the gearwheels (0.9·D₂≤Dₐ≤0.99·D₂).

Method, as described above, wherein the workpieces take the form of gearwheels having a gear ring and a flange, and a distance T between a first and second face of the device is greater than a distance ΔH between a face of the flange and an adjacent face of the gear ring.

The invention enables planar or flat storage of every workpiece in the thermochemical treatment, and crucial reduction in changes in dimensions and shape or warpage. The device of the invention is of simple construction and producible with a low level of complexity. Moreover, the device is resistant to high temperature, mechanically robust and designed for a long period of use. In preferred embodiments of the invention, the contact surface area between the workpiece and the device is small relative to the support surface area, such that intense and largely conforming flow of a quench fluid over the workpiece surface, for example of nitrogen or oil, is assured. Moreover, the device is preferably configured such that the supported workpiece surface is virtually fully carburized. Thus, in low-pressure carburization, a “shielding effect”, also referred to as “masking”, in respect of carbon is reliably avoided.

It has been found that, surprisingly, the warpage of the workpieces can be reduced to a particular degree when each workpiece is stored or arranged between two devices of the invention in thermochemical treatment (also referred to hereinafter as “sandwich arrangement” or “sandwich method”). The cause of this advantageous effect has not yet been clarified. The inventor suspects that the sandwich arrangement homogenizes the flow of the cooling fluid used in the quenching around the workpiece surface. Accordingly, the effect of the sandwich arrangement in the quenching is more spatially homogeneous cooling of the workpiece, combined with a reduction in thermal warpage.

In the present invention, the term “envelope circle” refers to the minimum circumscribed circle (MCCI) of a cross section of a plate or ring of a device of the invention or of a cross section of a workpiece, for example a gearwheel. The envelope circle is determined according to DIN EN ISO 12180-1:2011-07 and DIN EN ISO 12181-2:2011-07 with the aid of a gearwheel inspection system or a coordinate measurement system. In the case of an equilateral polygon, the envelope circle corresponds to the circumscribed circle. In the case of a cross section having circular outer contour, the envelope circle is identical to the outer contour.

The flatness or axial runout of the device of the invention is determined according to DIN EN ISO 12181-1:2011-07 and DIN EN ISO 12181-2:2011-07 with the aid of a gearwheel inspection system or a coordinate measurement system.

The invention is elucidated in detail hereinafter with reference to figures and examples. Parts that are identical, similar and/or have the same function are given the same reference numerals. The figures show:

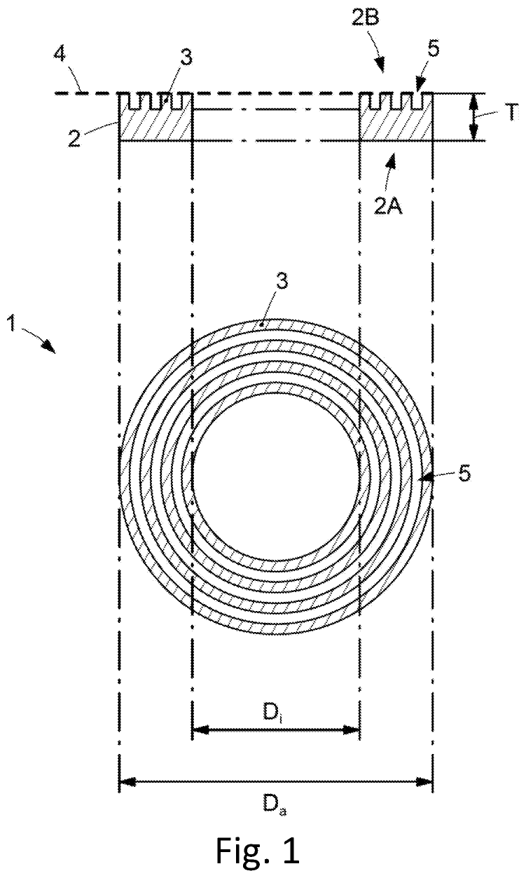

FIGS. 1-3 schematic top views and section views of devices of the invention;

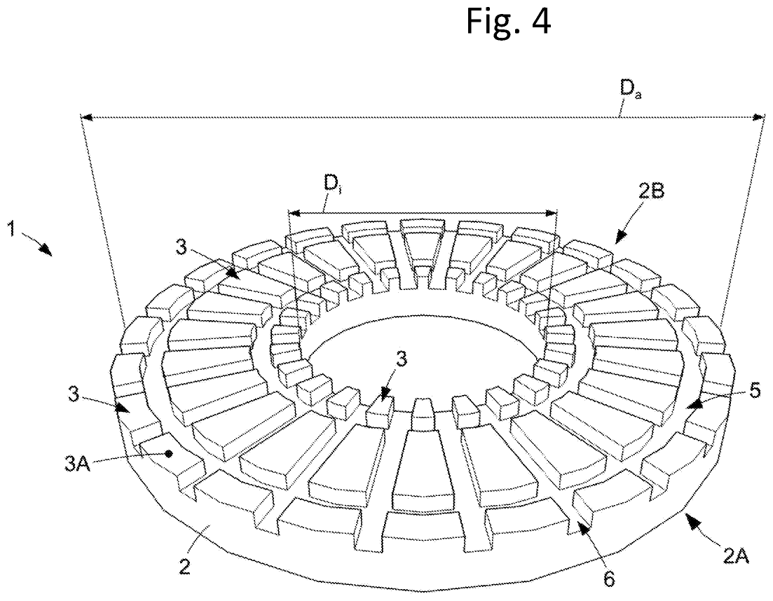

FIG. 4 a perspective view of a device of the invention;

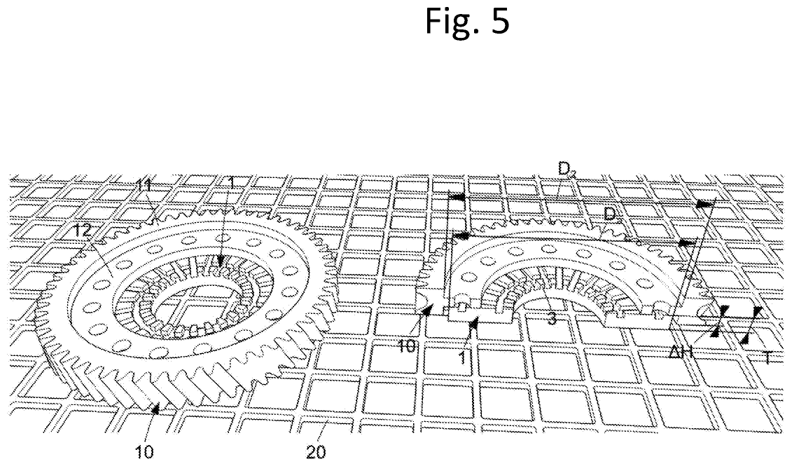

FIG. 5 a gearwheel borne in accordance with the invention;

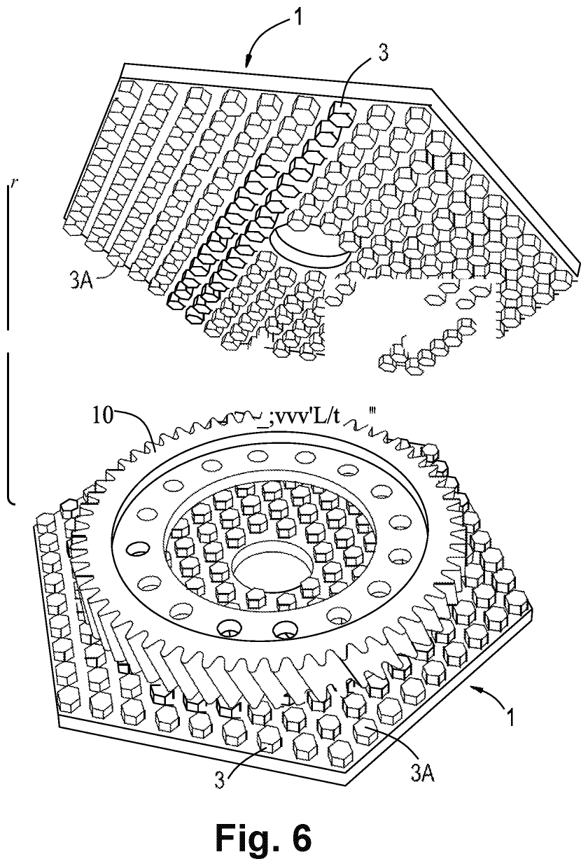

FIG. 6 a gearwheel with a first and second device;

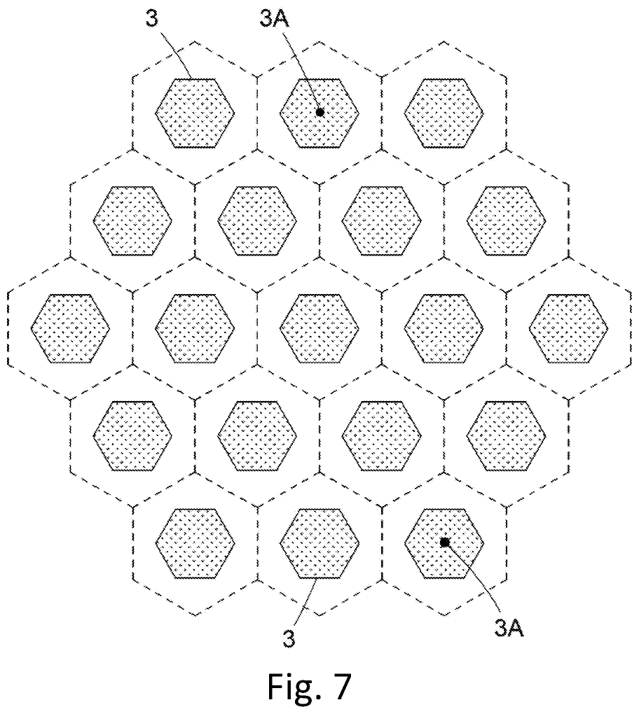

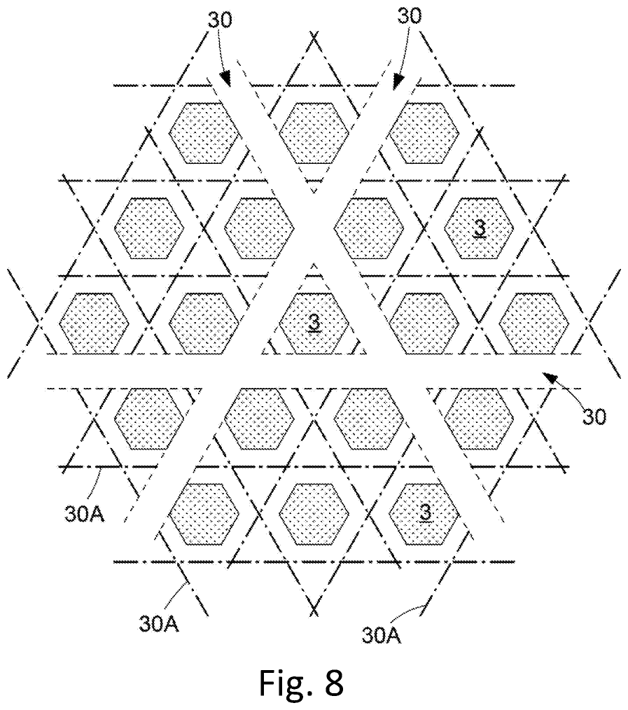

FIGS. 7-8 support elements arranged in a hexagonal pattern;

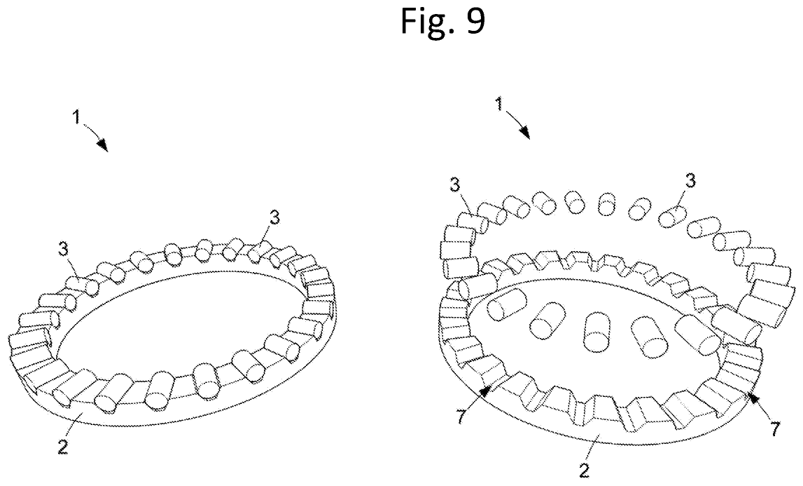

FIG. 9 a device with cylindrical support elements;

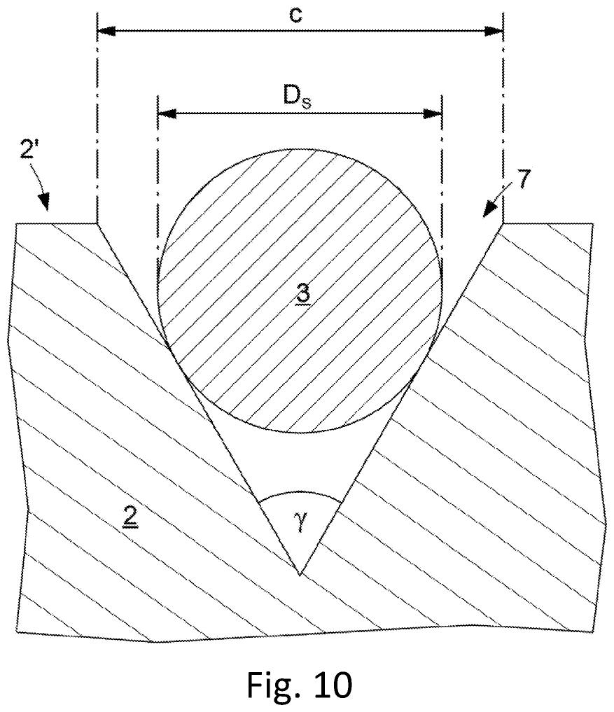

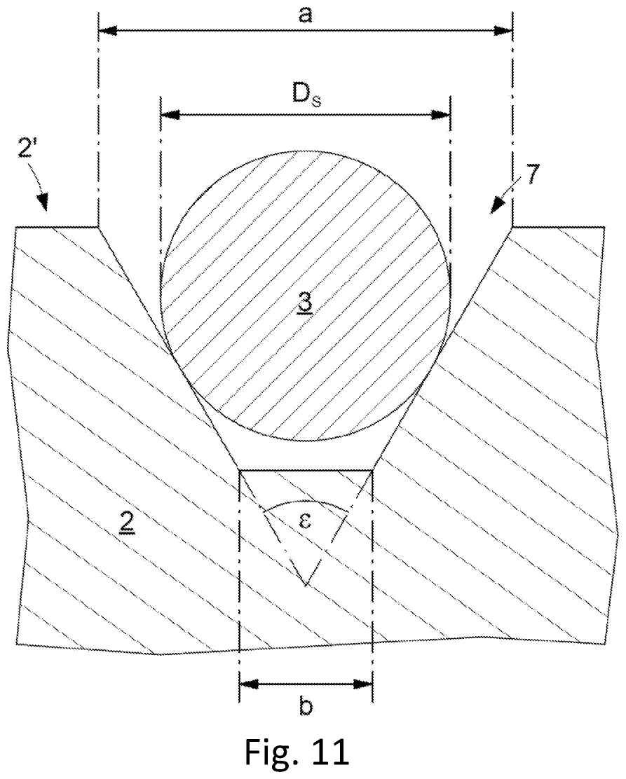

FIGS. 10-11 section views of support elements borne in recesses.

FIG. 1 shows a schematic top view and a section view of a device 1 of the invention with a ring 2 having a first face 2A and a second face 2B. Circular support elements 3 are disposed on the second face 2B. Every two support elements 3 are separated from one another by a circular recess or groove 5. The first face 2A is bounded by a flat surface or outer surface. The support elements 3 are set up such that at least three points on the surface of each support element 3 are arranged at a perpendicular distance T from the outer surface of the first face 2A, and a perpendicular distance of each point on the surface of the support elements 3 from the outer surface of the first face 2A is not more than T. The support elements 3 bound a support plane 4.

The ring 2 in the device 1 shown in FIG. 1 essentially has the shape of a circular cylinder having an outer and inner diameter Dₐ and Dᵢ respectively. The device 1 shown in FIG. 1 is in one-piece form and made from a material of high thermal stability, for example graphite or carbon fiber-reinforced carbon (CFRC).

Expediently, the device 1 is manufactured by material-removing processing, especially by means of turning or circular milling and optionally linear milling from plates or cylindrical disks of graphite or carbon fiber-reinforced carbon (CFRC).

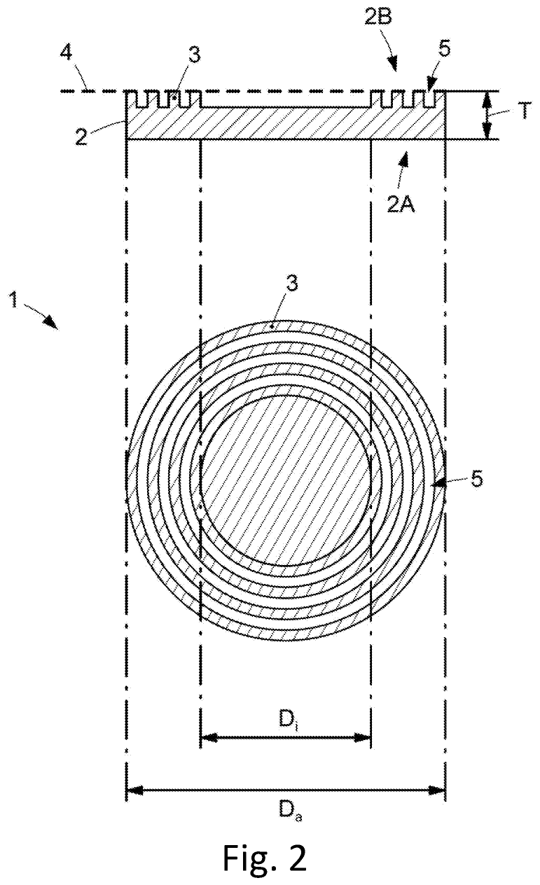

FIG. 2 shows a schematic top view and a section view of a further device 1 of the invention with a plate 2. Apart from the plate 2, the device 1 shown in FIG. 2 is of the same design as that in FIG. 1.

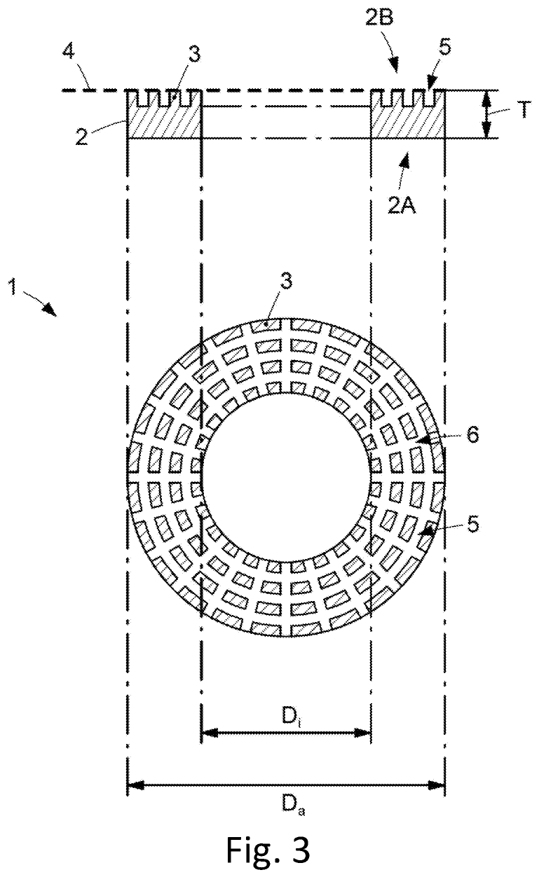

FIG. 3 shows a further device 1 of the invention with a ring 2 and support elements 3 that are separated from one another by circular recesses 5 and radial recesses 6.

FIG. 4 shows a schematic perspective view of a device 1 with a circular ring 2 having an outer diameter Dₐ, an inner diameter Dᵢ, and support elements 3 having support surfaces 3A, wherein the support elements 3 are separated from one another by circular and radial grooves 5 and 6 respectively.

FIG. 5 shows a perspective full view and section view of a gearwheel 10 with a gear ring 11 and a flange 12, borne on a device 1. The device 1 shown in FIG. 5 is of the same construction as that in FIG. 4. The outside diameter Dₐ of the device 1 is smaller than an external diameter D₂ of the flange 12. The external diameter of the flange 12 is less than/equal to an internal diameter of the gear ring 11. Only a face of the flange 12 is supported by support elements 3 of the device 1. By contrast, the support elements 3 are not in contact with the gear ring 11. Furthermore, FIG. 5 shows a carrier 20 in grid form, on which the device 1 with the gearwheel 10 is disposed. The carrier 20 is typically made from graphite or carbon fiber-reinforced carbon (CFRC).

A thickness or distance T between an outer surface of the first face facing the carrier 20 and a support plane of the device 1 facing the gearwheel 10 is greater than a distance AH between lower faces of the gear ring 11 and the flange 12. This ensures that the gearwheel 10 does not come into contact with the carrier 20.

FIG. 6 shows a perspective view of a gearwheel 10 with a first device 1 and a second device 1′. For illustration purposes—in the manner of an exploded diagram—the second device 1′ is shown in an “opened” position relative to the gearwheel 10. For the thermochemical treatment, a lower side of the gearwheel 10 is borne on the first device 1, and the second device 1′ is placed on an upper side of the gearwheel 10. This configuration, in which a gearwheel 10 is disposed between two devices 1 and 1′, is also referred to in the present invention as “sandwich arrangement”. The devices (1, 1′) shown in FIG. 6 are of the same design and each comprise a ring having a hexagonal outer contour and a multitude of hexagonally configured support elements 3, each of which has a support surface 3A. The support surfaces 3A of the device 1 and 1′ respectively bound a support plane on which the gearwheel 10 lies (device 1), and a support plane that rests on the upper side of the gearwheel 10 (device 1′).

FIG. 7 shows a schematic top view of support elements 3 in the form of equilateral hexagons, with support surfaces 3A of a device (1, 1′) of the invention, of the kind shown in FIG. 6. The support elements 3 are arranged in a two-dimensionally periodic pattern with hexagonal symmetry. The arrangement of the support elements 3 in a two-dimensional periodic pattern enables two-dimensionally homogeneous support of workpieces and virtually uniform flow of process gas and cooling fluid over the workpieces in the course of quenching. The repeat units (or Voronoi zones) of the hexagonal periodic pattern are shown in FIG. 7 by dashed lines. Each of the hexagonal support surfaces 3A is rotated by 30 degrees relative to the repeat unit of the hexagonal periodic pattern. This configuration enables simple and inexpensive production of the device of the invention from solid plates by means of material-removing processing. More particularly, the device can be manufactured by means of milling from a solid plate of graphite or carbon fiber-reinforced carbon (CFRC) (see FIG. 8).

FIG. 8 shows a top view, analogous to FIG. 7, of support elements 3 in hexagonal form that are arranged in a two-dimensionally periodic pattern having hexagonal symmetry. The support elements 3 are separated from one another by recesses 30 or grooves 30. Each of the recesses 30 runs along a center axis 30A. Each of the center axes 30A belongs to one of three groups of equidistant parallel straight lines, with the straight lines of two different groups being rotated relative to one another by an angle of 120 or 240 degrees.

FIG. 9 shows schematic perspective views of a device 1 of the invention in a simple view and in the manner of an exploded diagram. The device 1 comprises a ring 2 with receptacles or mounts 7 for cylindrical support elements 3. The receptacles or mounts 7 are in the form of radially oriented grooves with trapezoidal cross section. In an alternative embodiment of the device 1, not shown in FIG. 9, a longitudinal axis of the receptacles or mounts 7 is rotated by an angle of up to 45 degrees in a plane parallel to the outer surface of the ring 2 with respect to the respective radial direction. Preferably, the cylindrical support elements 3 are made from a material of high thermal stability, such as graphite, carbon fiber-reinforced carbon (CFRC), oxide-ceramic fiber matrix composite (OCMC) or another ceramic material.

FIG. 10 shows a section view of a device of the invention with a ring 2 having a receptacle 7 for a cylindrical support element 3 with outside diameter Dₛ. The receptacle 7 takes the form of a groove having a cross section in the form of an equilateral triangle. A base side of the equilateral triangle has a length c, and a vertex angle γ opposite the base side is in the range from 60° to 120° (60°≤γ120°). The receptacle 7 is configured in such a way that a support element 3 borne in the receptacle 7 projects beyond a face 2′ of the ring 2. Accordingly, the length c satisfies the relation Dₛ·cos(γ/2)<c<Dₛ·cot(45°−γ/4)

FIG. 11 shows a section view of a further device of the invention with a ring 2 having a receptacle 7 for a cylindrical support element 3 with outside diameter Ds. The receptacle 7 takes the form of a groove having a cross section in the form of a symmetric trapezium. A long and short base side of the symmetric trapezium have a length a and b respectively. An angle εenclosed by the trapezium limbs is in the range from 60° to 120° (60°≤ε≤120°). The receptacle 7 is configured such that a support element 3 borne in the receptacle 7 projects beyond a face 2′ of the ring 2. Accordingly, the lengths a and b satisfy the relations

Dₐ·cos(ε/2)<a<Dₛ·cot(45°−ε4)

and

0≤b≤Dₐ·cot(45°+ε/4)

respectively.

The invention illustrated and elucidated in detail by working examples in the present description is not limited by the examples disclosed. The person skilled in the art is able to infer a multitude of additional variations from the description without leaving the scope of protection of the invention. Embodiments disclosed by way of example in the description represent merely examples that should in no way be regarded as a limitation of the scope of protection, possible uses or the configuration of the invention. Instead, the description and the figures put the person skilled in the art in a position to rework the examples. At the same time, the person skilled in the art, with knowledge of the concept of the invention disclosed, is able to undertake various changes with regard to function, configuration and arrangement of individual elements of the examples without leaving the scope of protection defined by the claims and their legal equivalents disclosed in the description.

### EXAMPLE 1

72 untreated transmission gears made of steel and having a configuration of the kind shown in FIG. 5, with a gear ring having tip circle diameter 378 mm, a flange and an inner hole were provided. On each of the transmission gears, according to DIN EN ISO 12181-1:2011-07 and DIN EN ISO 12181-2:2011-07, concentric runout (i.e. circular radial runout tolerance) at the tip circle diameter (or the outer tooth flanks) and planar runout (i.e. circular axial runout tolerance) at a face of the gear ring were measured. The measurements were performed on a Gleason 300 GMS P gearwheel inspection system.

After the measurement, the transmission gears were carburized in an ALD ModulTherm® system at 950° C. under low pressure at about 15 mbar and then quenched by means of compressed nitrogen. The duration of the thermochemical treatment with the process steps of heating, carburizing, diffusion and quenching was 2 hours. 36 of the 72 transmission gears were borne on devices of the invention over the entire process duration. As shown in FIG. 5, the flange of each of the 36 transmission gears was supported by means of a graphite ring equipped with circular and radial support lands, with the entire gear ring projecting in a free-floating manner above the graphite ring in radial direction.

The other 36 transmission gears, in a conventional manner, were placed directly on a carrier in a lattice form, made of carbon fiber-reinforced carbon (CFRC).

After the thermochemical treatment, concentric runout and planar runout of each of the 72 transmission gears were measured again. The averages of the measurement results after the thermochemical treatment are shown in table 1.

TABLE 1
Average after thermochemical treatment

| | Concentric | Planar |
|---|---|---|
| | runout | runout |
| Without support (36 parts) | 62 μm | 71 μm |
| With support (36 parts) | 46 μm | 40 μm |

It is apparent from table 1 that, with the inventive support, the radial and axial warpage of the 36 transmission gears supported in accordance with the invention and the associated increase in concentric runout and planar runout as a result of the thermochemical treatment is respectively 26% and 44% lower compared to the 36 transmission gears placed directly on the support.

### EXAMPLE 2

214 untreated transmission gears made of steel and having a configuration of the kind shown in FIG. 5, with a gear ring having tip circle diameter 378 mm, a flange and an inner hole were provided. On each of the transmission gears, according to DIN EN ISO 12181-1:2011-07 and DIN EN ISO 12181-2:2011-07, concentric runout (i.e. circular radial runout tolerance) at the tip circle diameter (or the outer tooth flanks) and planar runout (i.e. circular axial runout tolerance) at a face of the gear ring were measured. The measurements were performed on a Gleason 300 GMS P gearwheel inspection system.

After the measurement, the transmission gears were divided into two production batches having 108 and 106 transmission gears and in each case carburized in an ALD ModulTherm° system at 950° C. under low pressure at about 15 mbar and then quenched by means of compressed nitrogen. The duration of the thermochemical treatment with the process steps of heating, carburizing, diffusion and quenching was 2 hours.

Table 2 shows the division of the transmission gears between the first and second production batches, and the configuration or use of the device of the invention for support and/or shielding of the transmission gears.

TABLE 2

| Device | Production batch 1 | Production batch 2 |
|---|---|---|
| None | 54 | 54 |
| Below | 10 | 10 |
| Above | 18 | 18 |
| Above & below | 25 | 25 |
| (sandwich) | | |

108 transmission gears, in a conventional manner, were placed directly on a carrier in lattice form, made of carbon fiber-reinforced carbon (CFRC).

In the case of 20 transmission gears, as shown in FIG. 5, the flange was supported by a graphite ring having circular and radial support lands, with the entire gear ring projecting in a free-floating manner above the graphite ring in radial direction.

36 transmission gears were placed directly on a carrier in grid form and a graphite ring was disposed on the top side of each transmission gear in such a way that the support lands of the graphite ring face downward, i.e. toward the transmission gear.

In the case of 50 transmission gears, two graphite rings were used in each case in a sandwich arrangement, with the bottom side of the flange of a transmission gear resting on a first graphite ring, and a second graphite ring being disposed on the top side of the flange.

After the thermochemical treatment, concentric runout and planar runout were measured again on each of the 214 transmission gears, and the respective starting value was subtracted from the measurement result obtained. The increase in concentric runout and planar runout caused by the thermochemical treatment is shown in table 3.

TABLE 3

| | | Concentric | Planar | |
|---|---|---|---|---|
| Device | Increase | runout | runout | |
| None | Average | 42 μm | 55 | μm |
| | Maximum | 194 μm | 125 | μm |
| Below | Average | 43 μm | 30 | μm |
| | Maximum | 75 μm | 51 | μm |
| Above | Average | 27 μm | 46 | μm |
| | Maximum | 91 μm | 108 | μm |
| Above & below | Average | 32 μm | 28 | μm |
| (sandwich) | Maximum | 80 μm | 85 | μm |

### LIST OF REFERENCE NUMERALS

1, 1′ . . . device for support or shielding

2 plate or ring

2′ . . . face of the plate or ring 2

2A . . . first face/outer surface of the device 1, 1′

2B . . . second face of the device 1, 1′

3 . . . support element

3A . . . support surface of a support element 3

4 . . . support plane

5 . . . circular recess/groove

6 . . . radial recess/groove

7 . . . receptacle for support element 3

10 . . . gearwheel

11 . . . gear ring

12 . . . flange

20 . . . carrier

30 . . . recess/groove

30A . . . groove axis/cutting axis/milling axis

T . . . distance between first face 2A and support plane 4

Dᵢ . . . internal diameter of the ring 2

Dₐ . . . diameter of the envelope circle of the plate or ring 2

D₂ . . . outer diameter of the flange 12

ΔH . . . difference in height between gear ring 11 and flange 12

Dₛ . . . diameter of cylindrical support elements 3

c . . . base side of a triangular cross section of a receptacle 7

Y . . . vertex angle of a triangular cross section of a receptacle 7

a . . . long base side of a trapezoidal cross section of a receptacle 7

b . . . short base side of a trapezoidal cross section of a receptacle 7

ε . . . vertex angle of a trapezoidal cross section of a receptacle 7

1. A device for support and flow guiding for metallic workpieces in thermochemical treatment comprising a plate or a ring having a first and second face, wherein the second face is equipped with three or more support elements and the support elements are bound a support plane.

2. The device as claimed in claim 1, wherein said device comprises N support elements with 10≤N≤200.

3. The device as claimed in claim 1, wherein the plate or the ring has a cross-sectional area Q, each support element has a support area, and the sum total of the support areas of all support elements is 10% to 50% of the cross-sectional area Q.

4. The device as claimed in claim 1, wherein the plate or the ring and the support elements are in one-piece form.

5. The device as claimed in claim 4, wherein the support elements are in the form of lands.

6. The device as claimed in claim 1, wherein the second face is equipped with receptacles for the support elements.

7. The device as claimed in claim 6, wherein the receptacles are in the form of grooves.

8. The device as claimed in claim 1, wherein the support elements are in the form of round bars.

9. The device as claimed in claim 1, wherein the plate or the ring is made from graphite or carbon fiber-reinforced carbon (CFRC).

10. The device as claimed in claim 1, wherein the support elements are made from graphite, carbon fiber-reinforced carbon (CFRC), oxide-ceramic fiber matrix composite (OCMC) or another ceramic material.

11. The device as claimed in claim 1, wherein a surface of the support elements is equipped with particles of a ceramic material and the particles have an equivalent diameter in the range from 5 to 1000 nm.

12. A method of thermochemical treatment of one, two or more metallic workpieces comprising disposing a device as claimed in claim 1 on a first and/or second side of each workpiece.

13. The method as claimed in claim 12, wherein the workpieces have a cross section having an envelope circle with diameter Dₖ, the device comprises a plate or a ring, the plate or the ring has a cross section having an envelope circle with diameter Dₐ, and 0.5·Dₖ≤Dₐ≤1.2·Dₖ.

14. The method as claimed in claim 12, further comprising carburizing one, two or more workpieces together in a furnace chamber, wherein one workpiece in each case is disposed between an upper and lower wall of the heating chamber in a vertical direction.

15. The method as claimed in claim 12, further comprising carbonitriding one, two or more workpieces together in a furnace chamber, wherein one workpiece in each case is disposed between an upper and lower wall of the heating chamber in a vertical direction.

16. The method as claimed in claim 12, further comprising quenching one, two or more workpieces together in a quench chamber, wherein one workpiece in each case is disposed between an upper and lower wall of the quench chamber in a vertical direction.
